(19) United States
(12) Patent Application Publication
(10) Pub. No.: US 2012/0173387 A1
(43) Pub. Date: Jul. 5, 2012

(54) E-Commerce electronic data centrally distributed and collected

(76) Inventor: Albert Talker, New York, NY (US)

(21) Appl. No.: 12/983,890

(22) Filed: Jan. 4, 2011

(51) Int. Cl. G06Q 30/00

(52) U.S. Cl. 705/27.1; 705/26.1

(57) ABSTRACT

A system and a method for electronic commerce allowing consumers to centrally receive and send electronic data from multiple merchants. The system includes a central server having software which gathers the electronic data including emails and events notification from member merchants directed to consumers accounts who maintain and register accounts on a centralized server. In an alternate embodiment, the merchants can request consumer's information from a consumer account and pass the information to the merchant's server.

### FIELD OF THE INVENTION

This invention relates generally to a method and system where certain information pertaining to a consumer is delivered from merchant servers and stored on a centralized server and is then centrally provided to consumers. The reciprocating end of this method delivers certain information pertaining to consumers and entered by consumers to be stored and electronically processed on participating merchant servers.

### BACKGROUND OF THE INVENTION

In the field of e-commerce, there exist a demand for businesses to be able to tailor their products, services and sale events to better match the needs and requirements of their customers. This demand exists in both the business-to-business (B2B) and the business-to-consumer (B2C) worlds. A particular example of such tailoring of merchant services allows a merchant to customize their offerings to a particular customer, or group of customers and by that target markets their products. In another example, marketing means can include catalogs, emails; sales news, and purchase history with the merchant and other relevant data that need to be delivered to their customers. However, with telephone marketing and direct email marketing laws merchants are not able to easily and directly access consumers. Accordingly in the field of e-commerce, there exist a need to provide the ability to provide merchants with the ability to offer detailed variation in content to be directly and centrally delivered to targeted consumers without violating consumers' privacy laws including unsolicited emails and telephones.

Furthermore, as information technology and network technology become more prolific, people find themselves repeatedly and manually inputting the same data into different computer systems. For example, consumers may find themselves having to manually input their personal and billing information via each merchant website through which they choose to complete an electronic commerce (“e-commerce”) or mobile commerce (“m-commerce”) transaction or apply for membership services (card). As the number of secure websites grows, consumers also find themselves having to manage numerous usernames and passwords. Thus, there is a need for a convenient and secure system for centralizing and automating the management of consumer information and its delivery to participating merchants.

Accordingly, there remains a need for a more secure, flexible and convenient system for storing information and a method for allowing the consumer to manage and distribute that information using a network-connected central data server. There further remains a need for such a system and method that provides central information storage and does not require a permanent download of proprietary software to a consumer's computer for management and distribution of the information.

Therefore, a need exists for a system that allows a consumer to send prescribed consumer information to a merchant's server over the Internet in a manner that offers security, allows access from any authorized merchant's server that has access to the Internet, and allows a consumer to centrality register with a merchant's server.

### SUMMARY OF THE INVENTION

It is therefore an object of the present invention to enable merchants to send targeted data to their consumers without the possibility of violating any laws.

It is therefore an object of the present invention to reduce the number of steps a consumer is required to perform in order to purchase a product over any network from a member merchant.

It is therefore an object of the present invention to centrally apply for loyalty membership over any network from any member merchant.

A further object of the present invention is to create consumer information stored centrally that can be accessed easily and transparently by a consumer and then provided to selected merchants.

A further object of the present invention is to allow flexibility in providing sales catalogs, emails, coupons and customer loyalty data to the consumers via centralized data server.

A further object of the present invention is to allow a consumer to conduct transactions using data stored on a consumer information server from any merchant's computer connected to the network on which the consumer information server resides.

A further object of the present invention is to provide a mechanism for direct marketing to consumer using a centralized data server.

A further object of the present invention is to permit a person to register with a centralized data server by providing consumer information to be stored on the centralized server.

A further object of the present invention is to allow a consumer to access a centralized data server in order to amend the consumer's stored information.

The invention provides a system and a method for allowing a merchant to customize and to personalize their business functions or content for each customer, group of customers or for a particular type of customer and deliver the business content to the consumer without violating any laws. Furthermore this invention provides a system for presenting a consumer's information to a merchant's computer to be processed on the merchant's computer.

In the field of e-commerce, there exist a demand for businesses to be able to tailor their products, services and sale events to better match the needs and requirements of their customers. This demand exists in both the business-to-business (B2B) and the business-to-consumer (B2C) worlds. A particular example of such tailoring of merchant services allows a merchant to customize their offerings to a particular customer, or group of customers and by that target markets their products. In another example, marketing means can include catalogs, emails; sales news, and purchase history with the merchant and other relevant data that need to be delivered to their customers. However, with telephone marketing and direct email marketing laws merchants are not able to easily and directly access consumers. Accordingly in the field of e-commerce, there exist a need to provide the ability to provide merchants with the ability to offer detailed variation in content to be directly and centrally delivered to targeted consumers without violating consumers' privacy laws including unsolicited emails and telephones.

A simple example of one of the embodiments of this invention is in the personalization of a targeted email, such that each customer may receive perhaps slightly different content, customized for their particular needs. The targeted email is sent to the central data server and can be viewed only when the consumer logs into the central data server to view his accounts details. As used herein, a user or customer may be a consumer or any other entity, such as another organization or company.

Furthermore, as information technology and network technology become more prolific, people find themselves repeatedly and manually inputting the same data into different computer systems. For example, consumers may find themselves having to manually input their personal and billing information via each merchant website through which they choose to complete an electronic commerce (“e-commerce”) or mobile commerce (“m-commerce”) transaction or apply for membership services (card). As the number of secure websites grows, consumers also find themselves having to manage numerous usernames and passwords. Thus, there is a need for a convenient and secure system for centralizing and automating the management of consumer information.

Accordingly, there remains a need for a more secure, flexible and convenient system for storing information and a method for allowing the consumer to manage and distribute that information using a network-connected central data server. There further remains a need for such a system and method that provides central information storage and does not require a permanent download of proprietary software to a consumer's computer for management and distribution of the information.

The system comprises a computer associated with a consumer (the “consumer's computer”), a computer associated with a merchant (the “merchant's database server”) and a centralized data server (the “centralized data server” or “CDS”) on which the necessary and desirable information about the consumer is stored. The consumer's computer, the merchant's database server, and the CDS are connected to a network, such as the Internet, and communicate using communication protocols. The consumer's computer operates Web browser software (the “consumer's browser”) or an email client software (“consumer's email”). The merchant's database server provides targeted data to the centralized data server and receives authorized consumer's data from the central data server. It further and performs other functions to process the received consumer's data. The merchant's database server may be a single device, or may, at the merchant's discretion comprise numerous devices which may or may not be co-located. The merchant's database server also operates software (“merchant software”) that communicates with the CDS. The CDS operates CDS software which provides access to information stored in various databases, logs, and/or data-structures.

The present invention allows merchants to receive customer information as designated by the consumer. During the process, a consumer logs into the centralized data server (CDS) and browses through his incoming email and marketing materials sent by the merchants' database servers. Then the customer may elect to provide to participating merchants several elements of the consumer's information account. In addition the consumer may request a specific merchant's offer and marketing materials. The Merchant's database server in response sends merchant's data and specific offer details to the consumer's information account. The merchant's data and response will be delivered to the consumer's computer through the CDS web server software.

According to the main embodiment, at the consumer's direction, selected information in the information account may be sent to authorized merchants through the CDS. The terms “merchant” or “vendor” are used herein in a general sense to refer to persons, businesses, enterprises or entities that make products or services available to consumers. As used herein, the terms “consumer,” “buyer,” and “user” are interchangeable.

Merchant's database server software and CDS software may, in some embodiments, be used to manage communications with the information account stored in the CDS. As an example, the Merchant's database server may execute a business process relating to a consumer-initiated activity, such as a retail transaction. The merchant's server-side software and the CDS software may exchange consumer information data from the CDS information account and use that information to automatically populate the input fields of a form that is to be submitted to a merchant's server or other network device by the consumer during an application, registration or transaction process.

In the preferred embodiment, the merchant's server also sends the consumer's information registered with the merchants to the CDS. If the consumer's information is forwarded to the CDS, then the CDS software saves the consumer's information in the CDS consumer's information account. If the consumer's information account is not forwarded to the CDS by merchants, then the consumer follows registers with the CDS using a CDS registration process managed through CDS web-server.

If the consumer elects to register with the CDS, during the registration process, the consumer's browser is sent a browser identifier. In the preferred embodiment, the browser identifier is a cookie. The browser identifier contains data which is cryptographically protected to enhance security. The browser identifier allows the CDS software to identify the consumer's browser and permits a customer to authenticate himself or herself, thereby permitting the CDS software to use the consumer's stored information in future transactions.

With respect to consumers, the system is optimized to provide all of the targeted marketing information provided by the merchants and purchasing information with the merchants to the consumer thereby allowing the consumer to verify the information. The system can also establish an editing session between the consumer's computer and the CDS to permit the consumer to select from options such as which credit card to use, which loyalty cards to register, the shipping address, and the shipping means.

In an alternate embodiment, a consumer can register with the CDS prior to purchasing a product from a specific merchant and the consumer details would be provided to the merchant by the CDS at the time of purchase. In yet another embodiment, the merchant sends an email message to a consumer through the CDS wherein the email message contains the proper links to the CDS to allow the consumer to register with the CDS prior to purchasing a product.

In yet another embodiment, a known (registered) consumer can access the CDS to amend the consumer's stored information and alert the participating merchants of this change.

### BRIEF DESCRIPTION OF THE DRAWINGS

FIG. 1 is a high-level block diagram illustrating a system in accordance with one or more exemplary embodiments of the present invention as disclosed herein.

FIG. 2 is a high-level block diagram illustrating the structure of the central information account stored in the Central Data Server in accordance with one or more exemplary embodiments of the present invention as disclosed herein.

FIG. 3 is a high-level block diagram illustrating the structure of the central information account stored in the Central Data Server and the interaction of data and information profiles schemas in accordance with one or more exemplary embodiments of the present invention as disclosed herein.

FIG. 4 is an abstract interaction diagram illustrating the interaction between various system components in accordance with one or more exemplary embodiments of the present invention.

FIG. 5 is a generalized interaction diagram illustrating the interaction between various system components and a data storage card/smart card in accordance with several exemplary embodiments of the present invention.

### DETAILED DESCRIPTION OF EXEMPLARY EMBODIMENTS

In one or more embodiments, a system and method is provided for enabling consumers and merchants to store and maintain a comprehensive information profile (hereinafter “centralized information account” 30) in a centralized data server 7 that is accessible over a distributed electronic network, such as the Internet 32. The information account 30 may be used to store any type of data desired by the consumer, including, for example, demographic information, financial information, medical information, family information, contact information, documents, multimedia files, etc. Furthermore, the information account may be used to store any type of data desired by the participating merchants including, for example, sale event information, specialized targeted catalogs, merchants coupons, merchants promotions, sale history, customer purchase history, multimedia files, etc. The centralized data repository is preferably accessible via a network by any authorized network device. In various embodiments, no specialized application programs are required to be permanently downloaded to the consumer's computer in order to access the central information account.

According to certain embodiments, at the consumer's direction, selected information in the central information account 30 may be accessed and, if desired, shared with authorized merchants 6, Financial Enterprises 8, business partners or any other entity that requires certain of the consumer's information. The terms “merchant”, “vendor” and “business partner” are used herein in a general sense to refer to persons, businesses, enterprises or entities that make products or services available to consumers. As used herein, the terms “consumer,” “buyer,” and “user” are interchangeable.

Merchant's Server-side software or temporary consumer-side software may, in some embodiments, be used to manage communications with the central Data Server 7 hereafter referred as “CDS”, central information account 30 and to automatically integrate central information account data into a process executed by the CDS software.

The data in the central information account is preferably stored in a SQL database alternatively using a tagged data format. In one embodiment, the data in the information account may be stored using the Extensible Markup Language (XML) data format, which is an open standard for describing data from the World Wide Web Consortium (“W3C”). As is known in the art, XML tags are used to define the types of information that are represented by the data element. The XML standard provides a great deal of flexibility in that custom tags may be defined for any type of information that the consumer may desire to store in the information account. Using any well-known XML-related querying, parsing, transforming and/or filtering techniques, and individual data elements in the information account may be accessed, updated, deleted, created, or otherwise manipulated.

The central information account 30 may be structured as one or more data aggregates, e.g., XML data aggregates. An entire XML data aggregate is stored within a data field of a database table. This data field is a long text field containing all of the information associated with the given record. In one embodiment, all consumer information in the central information account may be stored in a single XML data aggregate comprising consumer information elements and sub-elements. Attributes may also be associated with any element and sub-element in order to provide additional information. A transformation or filtering mechanism, such as “Style Sheets,” may be applied to the single XML data stream in order to extract only selected data elements there from at the direction of the consumer.

In an alternative embodiment, the central information account 30 may be normalized into a plurality of discrete data aggregates, each aggregate representing a predetermined information profile 29. An information profile refers to a package of consumer information relating to specific products, services offered by one or more merchants. For example, prescribing to sales events from specific merchants or loyalty card rewards for specific products.

Access constraints implemented in the system of the present invention according to one or more embodiments as described herein allow for the establishment of data profiles 28 and information profile 29. A data profile refers to a group of consumer data elements that are authorized by the consumer to be delivered to specific merchants at the request of the consumer. In other words, the data profile includes data from the central information account that may be used to in order retrieve information for use in commerce with any merchant that is a member of the CDS 7. In much the same way that a consumer may have one information account which specific data elements groups are each valid only on specified exchanges. For example, a loyalty card application might contain all consumer information that would be required to complete the application as defined in data profile 28. Individual information may be retrieved from the information account and transmitted by to authorized merchant at the request of the consumer in order to complete the membership application.

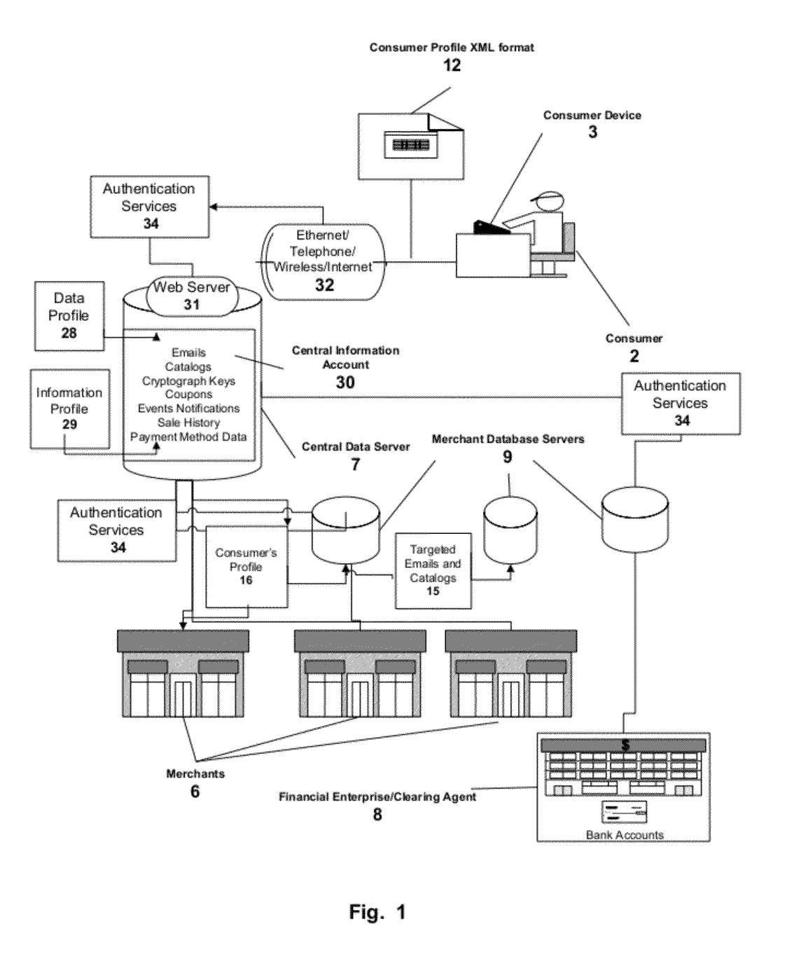

Exemplary embodiments of the present invention will now be described with reference to the drawings, in which like numerals represent like elements throughout the several figures. A high-level block diagram of a system in accordance with an exemplary embodiment of the present invention is shown in and described with reference to FIG. 1. As shown, a central data server 7 (CDS) is provided for storing consumer and merchant information that may be easily accessed from any network device attached to the network 32. The network 32 may comprise any telecommunication and/or data network, whether public or private, such as a local area network, a wide area network, an intranet, an internet and any combination thereof and may be wireline and/or wireless. Various methodologies as described herein may be practiced in the context of distributed computing environments. The network 32 thus provides for the open and seamless distribution of consumer information to and from the central information account 30.

In the system illustrated in FIG. 1, the high level exemplary operating environment encompasses various network devices for accessing and reading associated computer-readable media having stored thereon data and/or computer-executable instructions for implementing various methods of the present invention of data storage, management and distribution. Generally, a network device includes a communication device for transmitting and receiving data and/or computer-executable instructions over the network 32, and a memory for storing data and/or computer-executable instructions. A network device may also include a processor for processing data and executing computer-executable instructions, as well as other internal and peripheral components that are well known in the art (e.g., input and output devices). A network device may generally comprise any device that is capable of communicating with the resources of the network 32. A network device in this embodiment comprises Central Data Server 7, Consumer's Device 3, merchant database servers 9 and financial enterprise server 8. Any server in the system may interact with another server and the central data server 7 via the network 32 and can host a web server comprising one or more websites.

A consumer device 3 may comprise a desktop computer, a laptop computer, digital assistant (PDA), and the like. These and other types of consumer devices 3 will be apparent to one of ordinary skill in the art. For convenience, the following explanation will be made with reference to a client device 3 generically, but, unless otherwise indicated, it will be understood that the principles and concepts described will also encompass wired or wireless devices, as consumer device 3 illustrated in FIG. 1. Moreover, although exemplary embodiments will be described herein in the context of the Internet or a web-based environment, it will be appreciated that the various principles and methods of operation will be applicable or may be practiced in other environments as well.

According to a preferred embodiment, a consumer device 3 may execute a browser or another suitable application for interacting with web-server 31 hosted by a central data server 7 and other network devices. Through a graphical user interface provided by the web-server 31, the web-server 31 may require the consumer 2 (i.e., the operator of the consumer device 3) to input certain information pertaining to or associated with the consumer. The present invention allows the consumer to input information elements that can be transmitted from the central information account 30 to the merchants 6 for processing. Although exemplary embodiments of the present invention will be described herein in the context of a web-based environment, those skilled in the art will appreciate that other environments are suitable as well.

In general, the central information account 30 may be any data structure for storing consumer information. Preferably, however, the information account 30 is stored as a tagged data structure, such as one or more XML data aggregates. The data in the central information account 30 is preferably encrypted so that anyone gaining unauthorized access to the central information account 30 will not be able to read the data. Also, in a preferred embodiment, each information account 30 in the central data server 7 is encrypted separately, so that someone authorized to access the information account of one consumer may not also gain access to the information account of another consumer.

In accordance with a preferred embodiment, the consumers may maintain sole responsibility for storing and updating the information in the information account 30. Only the consumer, or those authorized by the consumer, may use the information account 30 to complete e-commerce or other electronic commerce activities. Consumers create an information account 30 either through a website hosted by the central data server 7 or by submission of information account by merchants 6 or by the financial enterprise 8.

Upon creation of a central information account 30, a consumer may be given an identification number, a username and/or a password. Other types of consumer authentication information are known in the art and may also be used in the context of the present invention. The system of FIG. 1 can provide the consumer with a variety of authentication services and methods 34 known in the art for accessing the information account 30, transferring selected information to a merchants and/or allowing a merchant 6 limited and constrained access to the information account 30, as described in further herein.

Authentication methods 34 include public/private key infrastructure, certificated authentication, IP authentication, Private questions, Key Entry, Crypto Key, Active Directory Authentication, LDAP Authentication and other authentication methods known to those skilled in the art.

Financial Enterprise/Clearing Agent 8 may be given the authorization from the consumer 2 to access its central information account 30 using one of the data profiles 28 stored in the central data server 7 (CDS). After authentication with the CDS 7 using authentication services 34 the financial enterprise/clearing agent 8 is able to retrieve consumer data elements to be processed for financial transactions submitted by merchants 6 or any financial transactions requested by consumer 2 and stored as a coded request in the central information account 30. In a particular example a consumer 2 may request a credit card from the financial enterprise/clearing agent 8 using the central data server 7 and central information account 30 data elements. Further example may include a consumer request from the financial enterprise 8 to receive detailed transaction information.

Data profile 28 is a set of pointers to the data stored in the central information account 30. The data profile may include xml tags to point and define data elements that could be delivered to merchants 6 or financial enterprises 8 in a controlled manner avoiding repetitive data entry by the consumer 8. The data profile includes XML tags, or database field names used to point to data elements stored in the central information account 30. The consumer may select specific data elements to be saved into one data profile 28 for specific merchants and another data profile 28 to be associated with another group of merchants 6 or financial enterprises 8. Upon request from merchant database server 9 only a specific data profile can be used to access customer's central information account 30.

Information profile 29 is a set of data filter definition to non consumer originated data (mostly merchant data) stored in the central information account 30. The merchants 6 can send to the information account electronic data including emails, catalogs, coupons, events notifications, sales items, sales history and other targeted marketing information as defined in the information profile 29. The information profile 29 may include xml tags or object names to define filtered data elements that could be delivered by merchants 6 or financial enterprises 8 in a controlled manner so the merchant database servers will process only information defined in the profile and upload that information to the central data server 7, avoiding sending information not requested by consumer 2 and not defined in the information profile 29. The information profile includes filter definition including XML tags, database field names and object names to data elements that can be stored in the central information account 30. The consumer may select specific information elements to be retrieved or filtered from merchant database server 9 and financial enterprises 8 using one information profile 29 for specific merchants and another information profile 29 to be associated with another group of merchants 6 or financial enterprises 8. Upon submission of information profile 29 to the merchants or financial enterprises, the information profile 29 will be used to process the data elements as defined in the profile in order to upload to the central data server 7 only requested information as indicated in the profile 29. For example one profile may include email submission only and the second profile may include emails, catalogs and sales events submissions by the merchants 6 who have authorized access to the central data server 30 and to the specific consumers through their central information account 30.

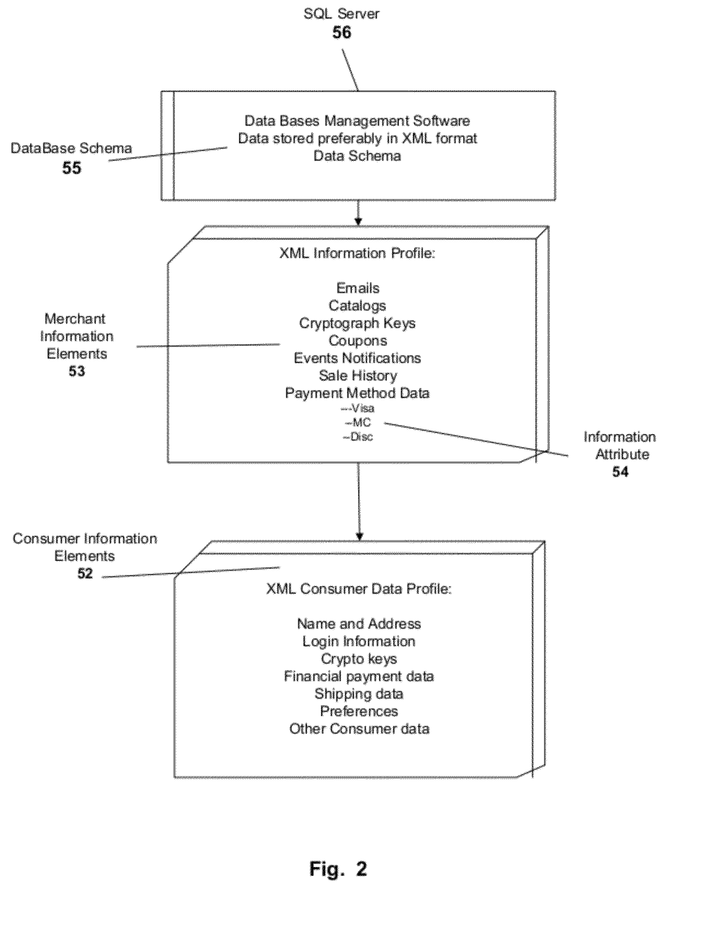

Upon creation of the central information account 30 merchants 6 upload to the central data server 7 targeted marketing data 15 based on the information profile 29 entered by the consumer 2. Information profile 29 will be discussed in detail in FIG. 2. The merchants 6 can upload to the central information account electronic data including emails, catalogs, coupons, events notifications, sales items, sales history and other targeted marketing information. The uploaded information is stored in the CDS 7 in any data structure for storing consumer information known in the art. Preferably, however, the information uploaded by the merchant 6 into central information account 30 should be stored as a tagged data structure, such as one or more XML data aggregates.

Those skilled in the art will appreciate that the illustration and discussion of exemplary embodiments with reference to FIG. 1 is provided as a generalized example only. Specific details regarding data formats and network communication protocols have been omitted, as such details are well known in the art. Furthermore, the present invention is not intended to be limited to the use of any particular data formats or protocols. Any existing or future formats or protocols may be used without departing from the spirit and scope of the invention. Furthermore, many network components were not shown or discussed with reference to FIG. 1, such as gateways, routers, hubs, switches, firewalls, DNS servers, authentication servers, certificate authorities, and the like. The functions and roles of such network components are also well known in the art and need not be described in detail herein.

FIG. 2 provides an abstract illustration of a central information account 30 in accordance with an exemplary embodiment of the present invention as described herein. In the illustrated embodiment, the consumer information is stored in the central information account 30 as a single tagged (delimited) data stream. Those skilled in the art will recognize that XML provides a suitable tagged data format for use in connection with the present invention. However, other tagged data formats can be employed as well. Thus, references to the XML standard in connection with exemplary embodiments of the present invention are not intended to limit the scope of the present invention. The single XML data stream comprises a plurality of consumer information elements 52 and plurality of merchant information elements 53. A consumer information element 52 and merchant information element 53 may be divided into any number and/or level of sub-elements. As is well known in the art, an XML consumer information element and merchant information element may also be associated with one or more attributes. An attribute 54 may provide additional information about the content, structure or formatting of a consumer information element 52 and the merchant information element 53.

A consumer information element 52 may comprise any type of data or information, including text strings, objects, files, applications, etc. Obviously, the more consumer information that is stored in the central information account 30, the larger the XML data stream will be. The size of the XML data stream is limited only by the hardware and software limitations of the system (e.g., memory size, processor speed, bandwidth, etc).

A merchant information element 53 may comprise any type of data or information, including text strings, objects, emails, web files, digital files, applications, etc. Obviously, the more consumer information that is stored in the central information account 30, the larger the XML data stream will be. The size of the XML data stream is limited only by the hardware and software limitations of the system (e.g., memory size, processor speed, bandwidth, etc).

An information account 30 is preferably unique to a single consumer 2. Each central information account 30 is stored in the central data server 7 may thus comprise a discrete XML data stream. Each central information account 30 stored in the central data server 7 may be individually encrypted. For example, one method for encrypting an information account 30 may involve use of the consumer's 2 public key. Accordingly, only someone having access to the consumer's private key will be able to decrypt the consumer's information. Many other and/or additional methods for encrypting information accounts 30 and/or the entire central data server 7 will occur to those skilled in the art.

As depicted in FIG. 2, illustrates an exemplary database schema 55 in accordance with one or more exemplary embodiments of the present invention as disclosed herein. The central information account data 30 may be stored in any database management systems known in the art. The preferred embodiment depicts SQL server 56 with database schema 55 used for database management system. In particular, the database schema 56 represents the situation where the information account 30 is segmented into multiple discrete data aggregates, the same as the XML tags. The database schema 56 may include the same or similar data fields as the XML schema 52 and 53.

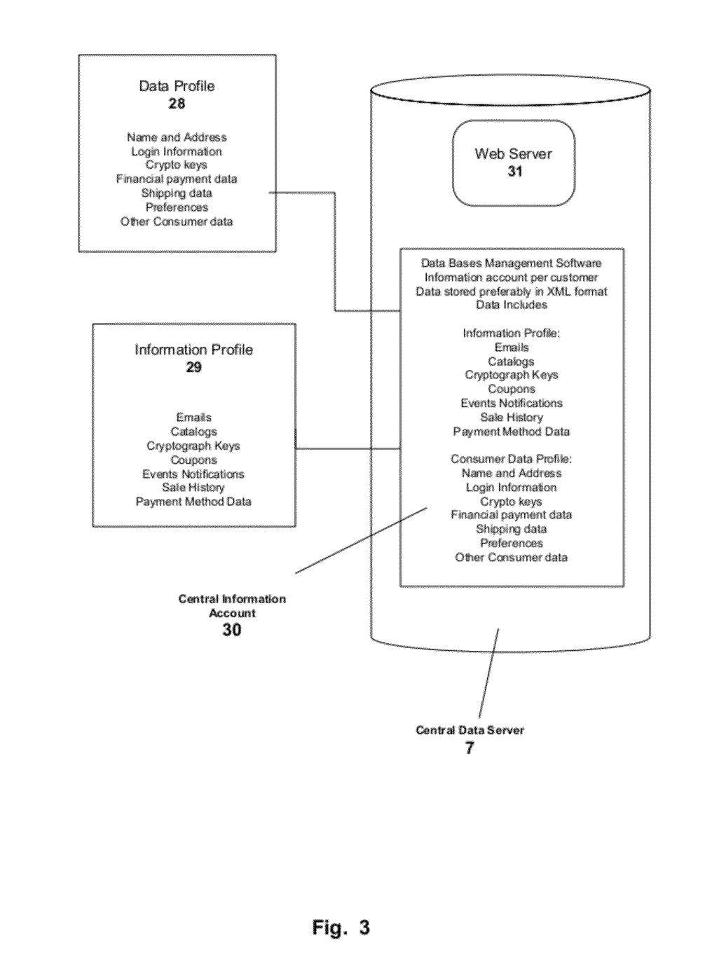

FIG. 3 provides an abstract illustration of a central information account 30 in accordance with an exemplary embodiment of the present invention as described herein. In the illustrated embodiment, the consumer information is stored in the central information account 30 as a single tagged (delimited) data stream. Those skilled in the art will recognize that XML provides a suitable tagged data format for use in connection with the present invention. However, other tagged data formats can be employed as well. Thus, references to the XML standard in connection with exemplary embodiments of the present invention are not intended to limit the scope of the present invention. The central information account data 30 may be stored in any database management systems known in the art. In the preferred embodiment SQL database server is used for database management system. In particular, a database schema is used where the information account 30 is segmented into multiple discrete data aggregates, the same as the XML tags defining the central information account 30 data elements. The database schema may include data fields for columns definition the SQL database or will use data elements of the XML schema to be stored as XML data, stored into corresponding data tables in the SQL database.

An information account 30 is preferably unique to a single consumer 2. Each central information account 30 is stored in the central data server 7 may thus comprise a discrete XML data stream. Each central information account 30 stored in the central data server 7 may be individually encrypted. For example, one method for encrypting an information account 30 may involve use of the consumer's 2 public key. Accordingly, only someone having access to the consumer's private key will be able to decrypt the consumer's information. Many other and/or additional methods for encrypting information accounts 30 and/or the entire central data server 7 will occur to those skilled in the art.

Web-server 31 integrated with the central data server 7 provides a graphical user interface enabling the consumer 2 to interact with the central data server 7 and the central information account 30. The web-server 31 may require the consumer 2 (i.e., the operator of the consumer device 3) to input certain information pertaining to or associated with the consumer and then enable the consumer to view/edit/delete the data elements in the central information account 30. Furthermore, the web-server 31 may provide programmable interfaces to the merchants and other network devices in order to access the records stored in the central data server 7.

Data profile 28 is a set of pointers to the data stored in the central information account 30. The data profile may include xml tags to point and define data elements that could be delivered to merchants 6 or financial enterprises 8 in a controlled manner avoiding repetitive data entry by the consumer 8. The data profile includes XML tags, or database field names used to point to data elements stored in the central information account 30. The consumer may select specific data elements to be saved into one data profile 28 for specific merchants and another data profile 28 to be associated with another group of merchants 6 or financial enterprises 8. Upon request from merchant database server 9 only a specific data profile can be used to access customer's central information account 30.

Information profile 29 is a set of data filter definition to non consumer originated data (mostly merchant data) stored in the central information account 30. The merchants 6 can send to the information account electronic data including emails, catalogs, coupons, events notifications, sales items, sales history and other targeted marketing information as defined in the information profile 29. The information profile 29 may include xml tags or object names to define filtered data elements that could be delivered by merchants 6 or financial enterprises 8 in a controlled manner so the merchant database servers will process only information defined in the profile and upload that information to the central data server 7, avoiding sending information not requested by consumer 2 and not defined in the information profile 29. The information profile includes filter definition including XML tags, database field names and object names to data elements that can be stored in the central information account 30. The consumer may select specific information elements to be retrieved or filtered from merchant database server 9 and financial enterprises 8 using one information profile 29 for specific merchants and another information profile 29 to be associated with another group of merchants 6 or financial enterprises 8. Upon submission of information profile 29 to the merchants or financial enterprises, the information profile 29 will be used to process the data elements as defined in the profile in order to upload to the central data server 7 only requested information as indicated in the profile 29. For example one profile may include email submission only and the second profile may include emails, catalogs and sales events submissions by the merchants 6 who have authorized access to the central data server 30 and to the specific consumers through their central information account 30.

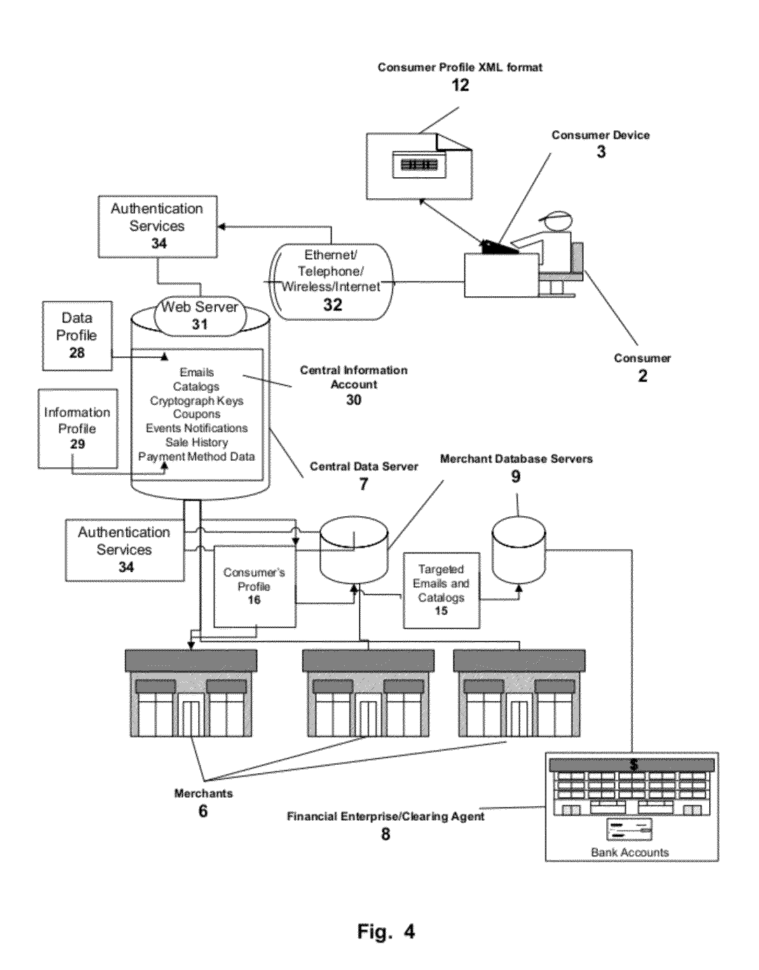

FIG. 4 is a generalized interaction diagram illustrating the interaction between various system components of certain exemplary embodiments of the present invention in connection with consumer-controlled storing, managing and/or distributing information and with the Financial Enterprises direct integration with vendor database servers. The exemplary embodiments discussed with reference to FIG. 4 employ a web-browser to manage communication and data session between the client device 3 and the central data server web-server 31. Alternative embodiments employing a server-side application instead of the web-server 31 will be discussed below. Those skilled in the art will appreciate the differences between the interactions involving the network devices as web-server 31, consumer devices 3 and merchant database servers 9.

With respect to consumers 2, the system is optimized to provide all of the targeted marketing information provided by the merchants and purchasing information with the merchants to the consumer thereby allowing the consumer to verify the information. The system can establish an editing session between the consumer's device 3 (consumer's computer) and the CDS 7 through its web server 31 to permit the consumer to select from options such as which credit card to use, which loyalty cards to register, the shipping address, and the shipping means.

In an alternate embodiment, a consumer 2 can register with the CDS 7 prior to purchasing a product from a specific merchant and the consumer details would be provided to the merchant database server 9 by the CDS at the time of purchase. In yet another embodiment, the merchant 6 sends an email message to a consumer 2 through the CDS 7 wherein the email message contains the proper links to the CDS to allow the consumer to register with the CDS prior to purchasing a product. In yet another embodiment, a known (registered) consumer can access the CDS 7 to amend the consumer's stored central information account 30 and alert the participating merchants 6 of this change.

In the preferred embodiment, the consumer 2 has the option of indicating directly to the merchants 6 that the consumer is a registered consumer with the CDS 7. The merchant's database server 9 has means to determine and verify that a consumer is a registered consumer on the CDS 7. If the consumer claims to be a registered consumer, merchant's offers, catalog and other data as defined in the information profile 28 is forwarded to the CDS. If the consumer does not claim to be a registered consumer, then the merchant's web server software acquires the consumer's data from the customer input form and uploads the information to the CDS 7 to be stored in the central information account 30. In the preferred embodiment, the merchant's database server 9 determines which products can be sold to the consumer using CDS 7. For instance, a consumer 2 in one state may not be able to purchase a firearm if the law governing the consumer or merchant does not permit such a transaction and it is the merchant obligation to verify these laws. The merchant's database servers 9 evaluates the information acquired from its particular data entry forms or central account information 30 received from the CDS 7 to determine if the information from the consumer is sufficient, and is abided by the law in order to complete the purchase transaction or other merchant's business transactions. In the preferred embodiment, the consumer is provided the option of registering with the CDS directly or through the participating merchants and financial enterprises.

When registering through a merchant and if the consumer elects to become a CDS registered consumer, then the merchant's database server 9 connects the consumer 2 to the CDS 7 directly or through a URL. In an alternate embodiment, the merchant's database server 9 forwards the registration data to the CDS9 after the registration data is collected on the merchant database server 9. The registration connection between the CDS and merchant database server can be established in any manner as known in the art. For example, in one embodiment the merchant's database server 9 sends the proper links to connect the consumer's browser with the CDS to allow the consumer to register with the CDS. In another embodiment, the merchant's database server software sends an email message to the consumer wherein the email message contains the proper links to the CDS to allow the consumer to register with the CDS.

In an alternative embodiment, the merchant can also send a consumer's information profile 12 to the consumer which the consumer browser or email service forwards to the CDS 7. The CDS 7 prompts the consumer for the consumer's information profile 12 which is preferably stored in XML format and uploaded to the CDS by the browser or using email service. In one embodiment, information profile 12 is part of the email message or the browser content. In another embodiment, the information profile 12 is in a file attached to the email message or sent as FTP upload to the CDS.

In the preferred embodiment, the registration information includes the consumer's identification number, email address, passphrase, default payment parameters, default shipping address, and default shipping means; however this list is not meant as a limitation. In alternate embodiments, the registration can include different information.

In the preferred embodiment, the authentication services 34 may use and store the Internet address for a consumer's browser, the consumer's email address, originating URL, browser cookie, private/public keys, cryptographic keys, digital certificates, SSO cookies and other authentication files used by the authentication services 34.

In another embodiment, an email message from the merchant 6 to the consumer 2 comprises a merchant's catalog and sale events and a link to the CDS Web page where the consumer can use in order to register with the CDS 7. In another embodiment, the consumer enters either the Internet address for the CDS web-server 31 or the direct Internet address for the registration process on the CDS. In another embodiment, the email message contains connection software which connects the consumer to the CDS. In one embodiment, the connection software is part of the email message. In another embodiment, the connection software is in a file attached to the email message.

Once the consumer accesses the CDS for first time registration, the CDS web-server 31 prompts the consumer for registration information and/or consumer profile 12. In the preferred embodiment, the registration information includes the consumer's identification number, email address, cryptographic keys, default payment parameters, default shipping address, default information profile 29, default data profile 28 and default shipping means, however this list is not meant as a limitation. In alternate embodiments, the registration information can include different information.

Before the registration process commences the CDS 7 web-server 31 determines if the consumer is known to the CDS 7, thus avoiding double entry of central account information 30 for the same consumer supplied by the consumer during a prior registration process. If the CDS software determines at the beginning of the registration process that the information provided by the consumer is insufficient to identify the consumer, then the CDS software prompts the consumer for entry of the complete registration data.

Once a consumer is registered in the CDS, the consumer's browser displays the consumer's information to the consumer who can amend the consumer's information using techniques known in the art. The consumer is able to add, delete or modify the consumer's information. Once the consumer completes his or her amendments, the consumer selects to either save or cancel the amendments.

In an alternate embodiment as depicted on FIG. 4, a financial enterprise/clearing agent 8 can access directly a merchant's database server 9 using authentication services 34. The financial enterprise/clearing agent 8 can access the consumer's profile 16 stored on the merchant database server and then use that profile to access the CDS 7 for any business transaction conducted with the merchants using financial information managed by financial enterprise/clearing agent 8. The consumer's profile 16 is a merchant sub-set of consumer data provided by the CDS from the central information account 30 belonging to this said consumer. In a specific example, a consumer 2 registered with the CDS 7 during a session with a merchant database server 9 for purchasing a product from a specific merchant would get financial authorization from a financial enterprise/clearing agent 8, and then the consumer details would be provided to the a financial enterprise/clearing agent 8 by the merchant database server 9 at the time of purchase or at the time of other business transaction.

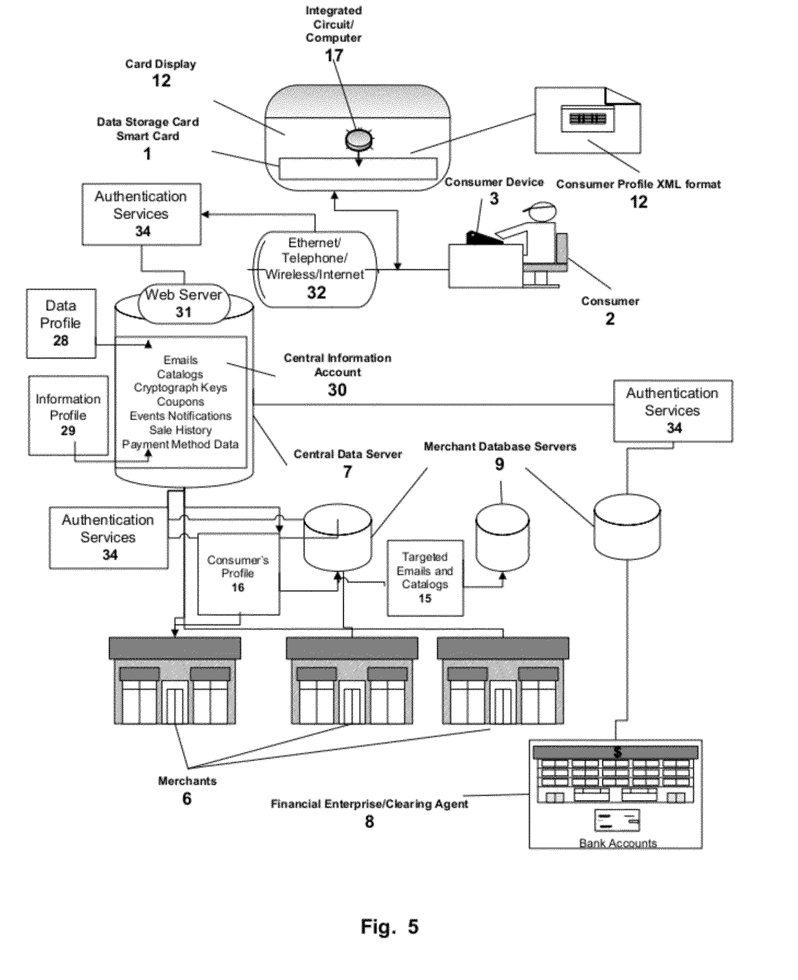

In the system illustrated in FIG. 5 is similar to FIG. 1 with the integration of Data Storage Card/Smart Card 1 and is a high level exemplary operating environment implementing various methods of the present invention. A consumer data storage card or smart card device 1 referred herein as “smart card device” may comprise a card display 12, an integrated circuit computer 17 and the like. This smart card device 1 and other types of consumer devices 3 including PDA, cell phone and laptop will be apparent to one of ordinary skill in the art. For convenience, the following g explanation will be made with reference to a smart card device 1. The smart card device has means to connect to the network 32 using network devices known in the art. Generically, but, unless otherwise indicated, it will be understood that the principles and concepts described will also encompass wired or wireless devices, as client device 3 illustrated in FIG. 1. Moreover, although exemplary embodiments will be described herein in the context of the Internet or a web-based environment, it will be appreciated that the various principles and methods of operation will be applicable or may be practiced in other environments as well. The data storage card/smart card device 1 is able to communicate with the central data 7 and input or receive information from the associated central information account 30 after authentication using authentication services 34. In particular the data storage card/smart card I is able input cryptographic keys and other customer data into the central information account 30, while receiving merchant's data 6 through the central data server 7.

Those skilled in the art will appreciate that the illustration and discussion of exemplary embodiments with reference to FIG. 5 is provided as a generalized example only. Specific details regarding data formats and network communication protocols have been omitted, as such details are well known in the art. Furthermore, the present invention is not intended to be limited to the use of any particular data formats or protocols. Any existing or future formats or protocols may be used without departing from the spirit and scope of the invention. Furthermore, many network components were not shown or discussed with reference to FIG. 5, such as gateways, routers, hubs, switches, firewalls, DNS servers, authentication servers, certificate authorities, and the like. The functions and roles of such network components are also well known in the art and need not be described in detail herein.

Although the present invention has been described in detail for purpose of illustration, it is understood that such detail is solely for that purpose, and variations can be made therein by those skilled in the art without departing from the scope of the invention. The preceding descriptions of the operations of the present invention are merely illustrative. In various embodiments of the disclosed inventions operational steps may be added, eliminated, performed in parallel or performed in a differing order. The apparatus and process of the present invention is defined by the following claims.

I claim:

1. A method for central delivery and distribution of electronic data to consumers from any of a plurality of merchants over a network, the method comprising the steps of: storing consumers' information accounts in a central data repository accessible via the distributed electronic network, the information accounts comprising a plurality of consumer information elements associated with a consumer and being subject to the consumer's control and management; receiving a request over the distributed electronic network from a merchant server; in response to the request, authenticating the merchant server based on the authentication information; retrieving and storing in said central data depository electronic data associated with said consumers' information accounts transmitted from the merchant's server; posting the said retrieved electronic data in the said central data repository into said consumer information accounts.

2. The method of claim 1, wherein the merchant server executes a communication protocol for communicating with the central data repository.

3. The method of claim 1, wherein the merchant server receives the selected consumer information elements and integrates the selected consumer information elements into a merchant's business process on behalf of the consumer.

4. The method of claim 3, wherein the step of integrating the selected consumer information elements into a merchant's business process further comprises the step of: allowing the consumer to input into said central data repository selected consumer information elements for processing by selected merchant servers.

5. The method of claim 1, wherein the selected consumer information elements are transmitted to the network in an encrypted format.

6. The method of claim 1, wherein the depository electronic data associated with said consumers accounts transmitted from the merchant server are transmitted to the network in an encrypted format.

7. The method of claim 1, wherein the merchant server interacting with the central data repository executes a server-side application for interacting with the management system that manages the central data repository.

8. The method of claim 1, wherein the centralized data server comprises storage means of data including Internet address of the consumer, Internet address of the merchant server, consumer electronic mail address, consumer registration information, consumer passphrase, consumer digital key, consumer payment information, consumer shipping address and consumer shipping method.

9. The method of claim 1, wherein the data transmitted to or received by the Central Data Server is in XML format.

10. The method of claim 1, wherein the method further comprising the steps of: hosting a web server on the said central data server accessible via the distributed electronic network by a client device executing a browser; executing a central data repository server-side application configured for communication with other host servers and client browsers.

11. A method for central delivery and distribution of electronic data to consumers from any of a plurality of merchants over a network, the method comprising the steps of storing consumers' information accounts in a central data repository accessible via the distributed electronic network, the information accounts comprising a plurality of consumer information elements associated with a consumer and being subject to the consumer's control and management; storing merchant's targeted marketing information in the information accounts in the central data repository accessible via the distributed electronic network, the merchant's information including a plurality of emails associated with a consumer, electronic catalogs, event notifications, coupons, multi-media messages and other electronic targeted marketing means; receiving a request over the distributed electronic network from a merchant server; in response to the request, authenticating the merchant server based on the authentication information; retrieving consumer data from the consumer information account and storing the retrieved data in the merchant's server; posting the said retrieved consumer data in the merchant server; processing the retrieved consumer data for business transactions executed by the merchant.

12. The method of claim 11, wherein the merchant server executes a communication protocol for communicating with the central data repository.

13. The method of claim 11, wherein the merchant server receives the selected consumer information elements and integrates the selected consumer information elements into a merchant's business process on behalf of the consumer.

14. The method of claim 13, wherein the step of integrating the selected consumer information elements into a merchant's business process further comprises the step of: allowing the consumer to input into said central data repository selected consumer information elements for processing by selected merchant servers.

15. The method of claim 11, wherein the selected consumer information elements are transmitted to the network in an encrypted format.

16. The method of claim 11, wherein the depository electronic data associated with said consumers accounts transmitted from the merchant server are transmitted to the network in an encrypted format.

17. The method of claim 11, wherein the merchant server interacting with the central data repository executes a server-side application for interacting with the management system that manages the central data repository.

18. The method of claim 11, wherein the centralized data server comprises storage means of data including Internet address of the consumer, Internet address of the merchant server, consumer electronic mail address, consumer registration information, consumer passphrase, consumer digital key, consumer payment information, consumer shipping address and consumer shipping method.

19. The method of claim 11, wherein the data transmitted to the Central Data Server and/or received by the Central Data Server is in XML format.

20. The method of claim 11, wherein the method further comprising the steps of: hosting a web server on the said central data server accessible via the distributed electronic network by a client device executing a browser; executing a central data repository server-side application configured for communication with other host servers and client browsers.
